(19) United States
(12) Patent Application Publication
(10) Pub. No.: US 2009/0171764 A1
(43) Pub. Date: Jul. 2, 2009

(54) Method for Real Time Data Processing to Produce Indexing of an Advertisement in Internet Research Tools

(76) Inventors: Sylvain Bellaiche, Paris (FR); Cesar Henao, Coye La Foret (FR)

Correspondence Address: FULBRIGHT & JAWORSKI, LLP, 666 FIFTH AVE, NEW YORK, NY, 10103-3198, US

(21) Appl. No.: 12/085,490

(22) PCT Filed: Nov. 27, 2006
(86) PCT No.: PCT/FR2006/002618

§ 371 Date: Sep. 22, 2008

Related U.S. Application Data
(60) Provisional application No. 60/739,869, filed on Nov. 25, 2005.

(51) Int. Cl. G06Q 30/00; G06F 17/30; G06Q 40/00; G06Q 10/00

(52) U.S. Cl. 705/10; 705/26; 705/14; 707/5; 707/2; 707/E17.017; 707/E17.044

(57) ABSTRACT

The present invention relates to a method of real-time data-processing designed for an indexing of an advertisement in Internet search tools, the present method is directed to a simultaneous, real-time management of the indexing position of one or more advertisements in one or more search tools. Particularly, the present invention enables the management of the recording and positioning of the advertisement website in search tools and directions in order to make the advertisement known to the web surfers, increase its visibility and thus increase the number of visitors to the advertiser's website. Accordingly, the present invention includes an algorithm for positioning the indexing of advertisements according to real-time bidding for keywords or combinations of keywords.

### FIELD OF THE INVENTION

An object of the present invention is a method of real-time data-processing designed for an indexing of an advertisement in Internet search tools. The present invention can be applied to special advantage but not exclusively in interactive advertising.

### PRIOR ART

At present, in the prior art, the indexing or referencing of an advertisement on the web interface in a search tool is done by intermediary companies. These intermediary companies link up an advertiser with a firm that hosts the search tool.

An advertiser is thus obliged to purchase sponsored links from the different intermediary companies so that its advertisement can be referenced on the interfaces of the search tools. Each sponsored link is sold with a batch of keywords chosen beforehand by the advertiser.

When an Internet surfer launches a query in the search tool using one of the keywords of the batch, the search tool transmits natural links to the surfer's interface, these natural links representing the most relevant Internet pages extracted from several databases. In addition to these natural links, the search tool, on the basis of these keywords, also transmits a set of sponsored or commercial links to the surfer's interface. These sponsored links appear in a preferred position as compared with the natural links of the relevant Internet pages.

These sponsored links are designed to attract the surfers' attention whenever these surfers use one of the keywords of the advertiser in the corresponding search tool. The sponsored links enable the advertisers to link up to the surfers at the precise time when they are looking for a product or a service.

However, this system of indexing or referencing advertisements as described has many drawbacks. Indeed, the surfer's behavior, which is increasingly random and fickle, prompts a reaction of competition among advertisers who are prepared to pay high prices to hold the surfers' attention.

The advertisers would therefore like their advertisements to be placed in the right position and be highly visible as compared with the other advertisements. Because of this competition, the intermediary companies auction out the best positions of each sponsored link. This auctioning is done on each keyword or on a combination of keywords.

An advertiser then bids for each keyword of its batch of pre-selected keywords. However, the advertiser has no means of knowing the results of the bidding and is therefore not assured of a good position for the indexing of the sponsored link purchased.

Furthermore, as the advertiser does not have a direct relationship with the firm hosting the search tool, the intermediary company needs to transmit and update the auction bids of said advertiser. This processing time may last at least one week. This is relatively lengthy for auctions and for the updating of positions of the indexing of the sponsored links.

The advertiser therefore has no way of obtaining real-time knowledge of the effect of value of the bidding for the keywords. It therefore cannot know the best bid that will enable it to place the purchased sponsored link in first position or in a preferred position.

Indeed, an advertiser spending a large budget to buy one or more keywords at an auction will have a favorable indexing for sponsored link, probably one in first position. However, the advertiser will not be able to check whether it has made a good choice or whether he has made his purchase at a loss. For example, if the advertiser purchases a keyword at a bid that is higher than the bids of the other advertisers, it obtains the best indexing. However, if the other advertisers have not made any bids or have made very low bids as compared with the advertiser's bid, then the advertiser will have spent a colossal amount of money at a loss for this indexing of its sponsored link. It could have got this indexing at a far smaller price.

Furthermore, the surfer not only has the habit of passing from one search tool to another but is becoming ever more demanding about what this advertisement can give him. Consequently, each advertiser is obliged to contact several intermediary companies to have a proper indexing of their advertisements in several search tools. The advertiser takes considerable time both in managing advertisements and in managing the auctions in each search tool.

### SUMMARY OF THE INVENTION

It is an aim of the present invention to overcome the different problems explained here above. To this end, the invention proposes a method of data-processing used for the simultaneous, real-time management of the indexing position of one or more advertisements in one or more search tools. A search tool brings together and organizes a vast quantity of information collected on the Internet. This information is then made available to surfers making online searches all over the world. A surfer can quite simply access the search tool by entering a search request in a field provided for this purpose. The results of the search appear firstly in a first zone called an organic zone in which the links to the sites are subjected to relevance criteria and secondly in a second zone in the form of sponsored links where the advertisers can invest in advertisements.

The invention enables the management, in the second zone, of the recording and positioning of the advertisement website in search tools and search lists in order to make it known to the surfers, increase its visibility and thus increase the number of its visitors.

To this end, the invention comprises an algorithm for positioning the indexing of advertisements according to bids for keywords or combinations of keywords.

To this end, the invention proposes a unique interface for each advertiser in order to centralize the creation of the keywords or combinations of keywords and the management of the different advertisement campaigns undertaken by an advertiser in at least one search tool. Centralizing these different actions through the Internet enables the advertiser to achieve real-time regulation of the position of the indexing of his advertisement or a set of advertisements belonging to the same campaign.

This interface enables an advertiser provided with identifiers to access a database listing a set of data preliminarily entered by the advertiser during a session for creating an advertiser profile and for updating its data during the management of the different advertising campaigns.

It is an aim of the invention to position advertisements in the search tool at the right time and in the right place to optimize and maximize the yield in terms of number of conversions into real commercial transactions of a viewing of an advertisement or set of advertisements.

The invention has an algorithm for assisting the advertiser in decision-making. This algorithm enables the advertiser to increase or lower the value of a bid for keywords. To this end, the algorithm carries out a real-time analysis of different indices determined according to different forms of behavior of the surfers. These decision-assistance means enable the advertisers to cope with budgetary constraints resulting from the result-related and performance-related approach dictated by the surfers' behavior.

The decision-making assistance algorithm also enables the advertiser to choose different types of strategy. A first strategy is used to create customer loyalty towards a commercial site, in analyzing the performance of each keyword as a function of the number of potential clients, the number of new clients, the number of recurrent clients and the loyalty rate of the clients.

A second strategy is used to increase sales by analyzing the number of product sales, the origin of each sale, the volume of product sales, the cost of acquisition of each customer and the category of product sold. This makes it possible to set up a hierarchy of products that draw customers more than other products.

The decision-making assistance algorithm is used to retrieve information on the surfers' behavior, i.e. the list of keywords for which a search is made by a customer and change in the viewing of the advertisement by the surfer during a real sale of said product. To this end, the algorithm of the invention has means for searching for the digital signatures of each customer. These search means enable the advertiser to track all the digital actions performed by the customer surfer when he visits the site which is the subject of the advertisement.

The invention also enables an advertiser to set up simultaneous advertising campaigns on several search tools and manage them in real time, using solely a terminal computer connected to the web.

The invention comprises an Interface hub directly installed in application servers. These application servers enable any advertiser to access the Interface hub of the invention without having to install any software on his computer.

The invention thus makes it possible to place an advertisement or a set of advertisements at the top of the search tool rankings on the basis of the bids. The invention is faster and more flexible than an indexing of sponsored links as implemented in the prior art. Similarly, the invention is capable of creating and managing the real-time indexing of a set of advertisements belonging to a same campaign. Now, in the prior art, this indexing is done in deferred time by the various specialized companies.

The invention enables the advertiser, through its unique interface, to create and manage one or more advertisements at any time, at the same time, and in one or more search tools. This gives the advertiser considerable gain in time.

With the invention, the advertiser is made aware of every bid on every keyword or combination of keywords and on every search tool. This enables the advertiser to make its bids fluctuate in real tine or to plan for them to be deferred, depending on the decision-making assistance indices. This optimizes and adapts the indexing of the different advertisements according to the increase or decrease in the number of requests for keywords made by the surfers.

The invention enables the advertiser to schedule the bidding according to a period, a date or a time slot so as to automatically activate the regulation of said bids.

More specifically, an object of the invention is a method for the processing of digital data relative to the real-time performance of an indexing of at least one advertisement in Internet search tools, characterized in that the method comprises the following steps:
a campaign is created,
a list of advertisements of at least one campaign is determined, this list comprising at least one advertisement,
for each advertisement of the list of advertisements, a list of keywords is determined,
at least one characteristic for assigning search tools is determined,
at least one search tool, in a range of search tools, is determined according to the different assigning characteristics determined,
the campaign is allocated to the determined search tool,
each keyword of each advertisement is assigned a fixed value,
decision-assistance indices are determined,
bidding strategies are determined as a function of the decision-assistance indices,
bids are made on each keyword of each advertisement as a function of the bidding strategies, in order to obtain the best indexing of the advertisement of the corresponding keyword.

Advantageously, the invention is also characterized in that it comprises the following steps:
the data of the campaign is recorded in databases,
the campaign is published,
the campaign is converted and adapted to each search tool,
the databases of the search tools are driven by means of applications programming interfaces,
at least one search tool, used to publish the advertisements, is chosen.

Advantageously, the invention is also characterized in that it comprises the following steps:
the number of campaigns to be made is determined,
the name of each campaign, the language used and the geographical target aimed at are determined,
at least one advertisement is created for each campaign,
the keywords used for each campaign are chosen,
maximum set values are assigned for each keyword,
the set values entered for each selected search tool are validated,
the value of a cursor is increased or decreased to regulate a bidding value of the selected keywords,
the chosen bidding value is validated,
the set of parameters comprising the search tools, the name of the campaign, the advertisement groups and the keywords is validated.

Advantageously, the invention is also characterized in that, when the set of parameters is validated:
the set of parameters is recorded in the databases,
the set of parameters is converted and adapted to each search tool,
queries are sent to the databases of each search tool in real time for each key word whose bidding value has been modified.

Advantageously, the invention is also characterized in that, to schedule actions for increasing or decreasing bidding values:
one or all the campaigns are selected,
one or all the advertisements are selected,
at least one keyword is selected,
at least one search tool is selected,
if the action is an action to be performed on a same day, then a date, a time or a time slot is selected, in indicating a starting time and an ending time,
if it is an action to be performed during a period of at least two days, then a starting date and an ending date are selected, days of the week are selected on which the actions are applied, and the time slot for which the action is applied is chosen,
the action to be performed, namely an increasing or a decreasing of the bidding value, is chosen
the scheduled action is validated and added to a list of scheduled actions to be performed automatically.

Advantageously, the invention is also characterized in that:
each scheduled action is performed in a chronological order,
for a scheduled action, there is a corresponding value of decrease or increase in the effective bidding value.

Advantageously, the invention is also characterized in that the increasing or decreasing of the bidding value modifies the indexing of the advertisement in a ranking of advertisements found by the search tool.

Advantageously, the invention is also characterized in that it comprises a step for determining indices of performances for the different search tools.

Advantageously, the invention is also characterized in that it comprises a step for determining a return-on-investment index.

Advantageously, the invention is also characterized in that the determining of the return-on-investment index comprises the following steps:
a search is made for the number of customers who have viewed the advertisement,
a search is made, among the customers who have viewed the advertisement, for the number of new customers,
a search is made, among the customers who have viewed the advertisement, for the number of customers who have already made at least one commercial operation with respect to this advertisement,
a search is made, among the number of customers who have viewed the advertisement, for those customers who have just performed a commercial operation on this advertisement,
depending on the different types of numbers of customers searched for earlier, an overall index of loyalty rate of customers for each advertisement is determined.

Advantageously, the invention is also characterized in that the determining of the return-on-investment index comprises the following steps:
a search is made for the number of sales of products made for each advertisement,
a search is made for the origin of each sale of products that is made,
a search is made for the volume of sales of products relative to a certain duration,
a search is made for the cost of acquisition of each customer to compute an overall cost of sales,
a hierarchy is set up between the different categories of products to determine firstly the most attractive products and secondly the most effective advertisements.

Advantageously, the invention is also characterized in that the steps performed to determine the return-on-investment index are achieved by decision-assistance means as well as means for tracking each potential customer in retrieving the list of keywords entered by customers and their consequences in terms of the conversion of a viewing of the advertisement into a sale.

Advantageously, the invention is also characterized in that:
the position of an advertisement of a site on a search tool, in a zone of sponsored links as well as in an organic referencing zone, is determined.

Advantageously, the invention is also characterized in that the determining of the position of an advertisement of a site in a search tool comprises the following steps:

a) an http query is sent to the search tool, using the domain name as a keyword,

b) the html result of this query is retrieved,

c) a scan operation is applied to the html result in searching for the occurrence of the domain name word,

d) an operation for identifying the organic referencing zone and/or the zone of sponsored links is applied,

e) an operation is applied for retrieving a list of sites present in the order that represents their positions,

f) an operation of correspondence of the displayed sites of this list with the site being searched for is applied,

g) if a correspondence is obtained, the position of the site being searched for is retrieved from the list of results,

h) if not, the operations a) to g) are applied in a loop by the sending of an http request to the search tool for the next results page.

Advantageously, the invention is also characterized in that, at the end of a certain predefined number of applications of the operations e) to h), the program of retrieval of the position of the site being searched for is stopped and a query of non-availability of the position is sent.

Advantageously, the invention is also characterized in that a transparent looped synchronization algorithm is applied to an advertiser:
firstly in determining all the header data of the search tool, and
secondly in enabling the advertiser to continue to manage its campaigns in real time by making use of the header data on demand without waiting for the end of the synchronization.

Advantageously, the invention is also characterized in that the determining of the header data of the search tool comprises the following steps:
the names of the campaigns are determined with their identifications,
the names of the application development systems are determined, also with their identifications, and
the names of the keywords are determined with only their identifications.

Advantageously, the invention is also characterized in that:
if it sought to obtain specific data which has not yet been downloaded by the transparent looped synchronization algorithm, the fact that this element is no longer available in the loop is transmitted to the algorithm and then this element is reintegrated into the algorithm for immediate execution,
if not, this specific data in the looped synchronization algorithm is replaced with a failure status and high priority equal to: “retry”.

The invention also relates to a hub for the implementation of said method for the processing of digital data in order to perform an indexing of an advertisement in Internet search tools, this hub comprising an advertiser interface enabling access by dedicated application servers to a database by means of data servers.

### BRIEF DESCRIPTION OF THE DRAWINGS

The invention will be understood more clearly from the following description and from the accompanying figures. These figures are presented by way of an indication and in no way restrict the scope of the invention.

FIG. 1 is a schematic view of a network server architecture implementing the invention.

FIG. 2 is a schematic view of an architecture of a network between a computer comprising the improved means of the invention, the search tool servers and an advertiser.

FIG. 3 is an illustration of means implementing the method of the invention.

FIG. 4 is a schematic view of the mechanism for the real-time computation of the position of an advertisement of a site in a search tool.

### DETAILED DESCRIPTION OF EMBODIMENTS OF THE INVENTION

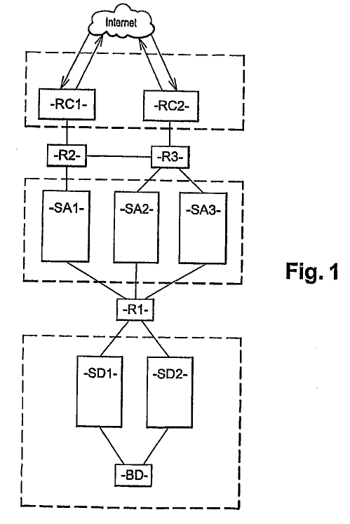

FIG. 1 is a schematic view of a network server architecture implementing the invention. The example of FIG. 1 shows a set of applications servers SA1 and SA3 which are inserted between a web server and databases B of the invention. The applications servers SA1 and SA3 have to manage the set of interconnection tasks of the advertiser such as the distribution of load between several servers and the management of access to the databases.

A web server is a software program enabling advertisers to access Internet pages by means of a browser installed in their terminal computers. The web server is used to host the site at which the interface of the invention used by the advertisers is hosted. The utility of the web server is that it takes charge simultaneously of several advertiser connections to the interface.

Access to an advertiser on the interface of the invention is subjected to a preliminary identification, enabling the applications servers to link up with data servers SD1, SD2. The data servers are used to control a large quantity of data and protect the data against unauthorized read and write access. The data servers handle a database BD which collects the different pieces of information and the identification, campaigns, advertisements, keywords, statistics etc pertaining to each advertiser of the interface. The database is installed in two data servers which are servers that are twins in order to distribute the load more efficiently.

Owing to the volume of processed data coming from the base and the number of simultaneous advertisers of the interface according to the invention, load distributors RC1, RC2 are set up, enabling the use of an application to be shared among several servers in order to circumvent the slowness of the system.

The load distributors RC1, RC2 are used to distribute received queries to the applications server SA1 and SA3. The queries come from search tools as well as from advertisers.

It is possible to add as many applications servers and as many data servers as needed, depending on the build-up.

A file storage server SA2 is connected to the applications servers SA1 and SA3. This server is accessible to the advertisers through the Internet.

Between the data servers SD1 and SD2 and the applications servers SA1 and SA3 and the storage server SA2 and the load distributors RC1 and RC2, the invention has placed routers R1, R2 and R3. These routers R1, R2 and R3 are interconnection apparatuses installed at a network node. Their function is to optimize data transmission in determining for themselves the best route to be taken.

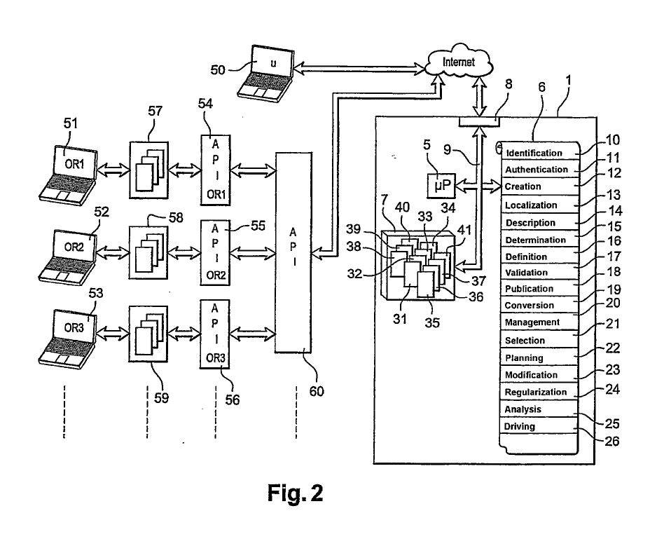

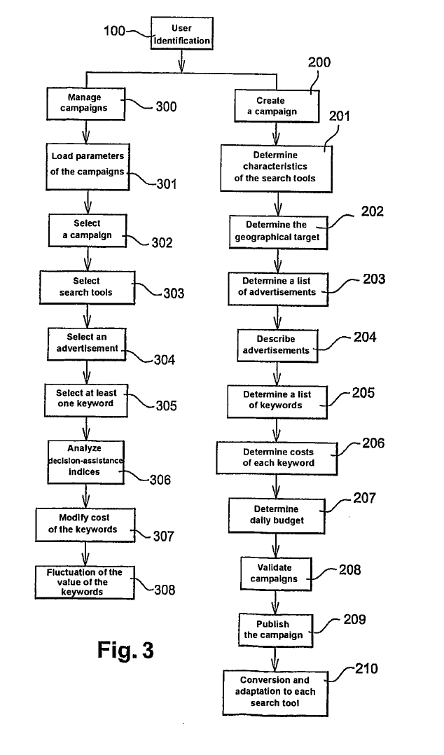

FIG. 2 is a schematic view of an architecture of a network between a computer including the improved means of the invention, the search tool servers and an advertiser. An advertiser is an advertiser that wishes to index its advertisement on the site of each search tool chosen. The example of FIG. 3 shows a control unit 1 of a computer acting as a dedicated server. The control unit 1 is an integrated circuit. The control unit 1 is connected to a terminal computer 50 of an advertiser through the Internet. The control unit 1 is connected non-exclusively to three search tool servers 51, 52, 53 through the Internet. The control unit 1 centralizes the resources and controls the access to them.

Each advertiser has an advertiser's account with a login name and a password enabling it to open a negotiation session on the computer 50 by authenticating itself with the control unit 1. The advertiser generally has a personal directory situated in a database of the control unit 1 in which it can store his data and to which it gets automatically connected when its session begins. Since the advertiser's data is centralized in the control unit 1, it can access it from any computer connected to the Internet.

The control unit 1 communicates respectively with the different servers of the Internet search tools 51, 52, 53 through various applications programming interfaces 54, 55, 56. These applications programming interfaces are better known as APIs. These APIs 54, 55, 56 enable interaction with relational databases through queries. These APIs 54, 55, 56 can be used to reach the databases 57, 58, 59 of each search tool almost transparently.

The queries that are sent to the search tools are first of all processed by a central API 60 which distributes, to the APIs 54, 55, 56 of each search tool server 51, 52, 53, the queries assigned to them.

The control unit 1 has a microprocessor 5, a program memory 6 a data memory 7 and an input/output interface 8. The microprocessor 5, the program memory 6, the data memory 7 and the input/output interface 8 are connected by a two-way communications bus 9.

The actions of the control unit 1 are carried out by the microprocessor 5 controlled by instruction codes of the program memory 6.

The program memory 6 has a zone 10 comprising instruction codes to identify an advertiser from a list of pre-recorded advertisers in order to open an advertiser session.

The program memory 6 has a zone 11 comprising instruction codes to authenticate a new advertiser from a first identification form 31 filled in by this advertiser. This first identification form 31 is stored in the data memory 7 and can be consulted and modified at any time by the new advertiser.

The program memory 6 has a zone 12 comprising instruction codes to create a campaign with the choice of one or more search tools, one or more advertisements, the name or the number of the campaign created. The program memory 6 has a zone 13 comprising instruction codes to define the language and geographical zone targeted for a campaign.

The program memory 6 has a zone 14 comprising instruction codes to prepare a description of the advertisement, i.e. the title, the description and the link to which the user is sent. The program memory 6 has a zone 15 comprising instruction codes to determine the keywords or combinations of keywords that are used to access the advertisement. The program memory 6 has a zone 16 comprising instruction codes to define firstly the budget to be allocated to an advertisement and secondly the value to be assigned to each keyword.

The program memory 6 has a zone 17 comprising instruction codes to control the set of data entered. The program memory 6 has a zone 18 comprising instruction codes to publish the campaign and generate a query sending script.

The program memory 6 has a zone 19 comprising instruction codes to convert the query sending script generated for each search tool selected. The program memory 6 has a zone 20 comprising instruction codes to launch an interface for the management of one or more campaigns.

The program memory 6 has a zone 21 comprising instruction codes to select one or all the campaigns, at least one search tool, one or all the advertisements of each campaign, or at least one keyword for each advertisement. The program memory 6 has a zone 22 comprising instruction codes to schedule actions of fluctuation of the values of the pre-selected keywords according to the date, the period and the value to be made to fluctuate. The program memory 6 has a zone 23 comprising instruction codes to make modifications of values.

The program memory 6 has a zone 24 comprising instruction codes to regulate the fluctuation of the bidding value for keywords. The program memory 6 has a zone 25 comprising instruction codes to analyze indices resulting from decision-assistance means for each campaign, each advertisement, each keyword, each search tool. The program memory 6 has a zone 26 comprising instruction codes to apply a transparent looped synchronization algorithm capable of driving the main API 60 and three secondary APIs 54, 55 and 56.

The program memory 6 has a zone 27 comprising instruction codes to create a campaign, with the choice of one more search tools, the name or the number of the campaign created.

FIG. 3 illustrates means implementing the method of the invention. FIG. 3 shows a preliminary step 100 in which the advertiser starts a session. This advertiser links up to a web interface provided by the applications server. The advertiser keys in its identifiers comprising a login name and a password. The system ascertains that the identity of the customer is part of the database. If the identity exists, it opens an advertiser's session and sends it an interface with a console.

The console works like a classic software program but does not need to be installed on the advertiser's computer. All that the advertiser needs is a web browser terminal. All the operations take place directly on the server. The advertiser no longer has any need of an intermediary as in the prior art. If these identifiers cannot be found in the database, the system asks the advertiser to create its identifiers.

This architecture enables two computers to communicate, for example between the search tool and the advertiser in varying the bids by means of mutual exchanges of queries.

From the console, the advertiser checks to see whether it wishes to create a campaign of advertisements in performing the steps 200 to 210 or whether it wishes to manage an already created campaign in applying the steps 300 to 308.

At the step 200, the control unit applies the algorithm for creating a campaign. At the step 201, the control unit determines at least one search tool as a function of the characteristics of the search tools defined by the advertiser. These characteristics may be especially the type of search tool, and the inflow towards a search tool. At the step 202, the control unit determines the geographical zones to be targeted on the basis of the advertiser's choices. The search tools determined at the step 201 are filtered as a function of the targeted geographical zone. At the step 203, the advertiser creates a list of advertisements for the advertising campaign. This list of advertisements may include at least one advertisement. At the step 204, the advertiser describes each advertisement of the campaign. This description is made in specifying especially the URL address of the site of the advertisement, the webmaster's email address, or the addition of other information such as the title of the homepage, a descriptive text, a category etc.

At the step 205, the advertiser defines the keywords or a combination of keywords for each advertisement of the campaign. An advertiser may determine for example 800,000 keywords in a campaign. A keyword is a word or a group of words selected in the title or in the text of the advertisement that characterizes the content of said advertisement.

The keyword is the word used by the surfer when making a query in a search tool in order to find relevant information on the Internet. Several keywords can be associated to formulate a query. If the search tool finds a keyword in its database, a link to the corresponding pages is created.

The keywords are also used during a referencing thus enabling a website to tell the search tools the keywords for which it wishes to be indexed.

At the step 206, the control unit determines the maximum and minimum values to be assigned to each keyword chosen by the advertiser. These values are fixed. At the step 207, the control unit determines a daily budget of each advertisement as a function of a pre-defined number of surfer visitors and of the values of each keyword.

At the step 208, the advertiser validates the advertising campaign. This validation leads to a step of verification of the campaign to make sure that the data entered by the advertiser is exact and presented appropriately. At the step 209, the control unit publishes the campaign by linking up at least one advertisement of the campaign to at least one search tool by means of a sponsored link to said search tool. At the step 210, the control unit sets up this link in performing a conversion and an adaptation of the sponsored link to all the sponsored links chosen.

At the step 300, the control unit applies the campaign management algorithm. At the step 301, the control unit loads the parameters of each campaign of each advertiser. This loading is an operation in which information, namely either a file or a program, is conveyed to the data memory of the computer from an auxiliary memory such as a hard disk drive.

The steps 302 to 304 enable each advertiser respectively to select at least one campaign, at least one search tool and at least one advertisement. The control unit brings together a large number of advertisers for the same keyword while at the same time enabling them to negotiate the best price for this keyword by bidding on the value of the keywords.

At the step 305, the control unit analyses the decision-assistance indices for each advertiser. At the end of this analysis, the control unit gives the advertiser exploitable data. This data enables the advertiser to apply bidding strategies.

To determine these decision indices, the control unit assigns a URL to each advertiser. This association enables the control unit to track or register the number of times an advertisement is viewed on a given search tool. The control unit also determines the number of viewings that are converted for example into purchases of the product advertised, or into reservations, orders, payments. The control unit determines the decision-assistance indices as a function of the number of times the advertisement has been viewed, the cost of the viewing etc. The control unit also determines the cost of sales and the volume of sales. By combining these pieces of data, the control unit can give the advertiser a piece of exploitable data which is the return on investment. For example, if surfers have viewed the advertisement 100,000 times and if each keyword enabling the surfer to access the advertisement costs [symbol] 0.10, then the price to be paid is [symbol] 10,000. If, among the 100,000 visitors, there are 60 surfers who have made purchases yielding [symbol] 200,000 then, given the return on investment, the advertiser will tend to raise its bids in order to optimize its indexing in the search tool in question.

These bidding strategies enable the advertiser to fluctuate its bids in the step 307, depending also on the bids made by the other advertisers.

At the step 308, the bid price drops according to the number of orders made throughout the operation. The greater the number of advertisers of a product, the greater the drop in its price. Finally, each advertiser benefits from the price reached by the group. The price of a product evolves in steps according to the number of orders. The control unit makes a graph associated with each of the keywords in order to enable each user to follow its development in real time.

The control unit assigns the most favorable indexing to the advertiser making the highest bid.

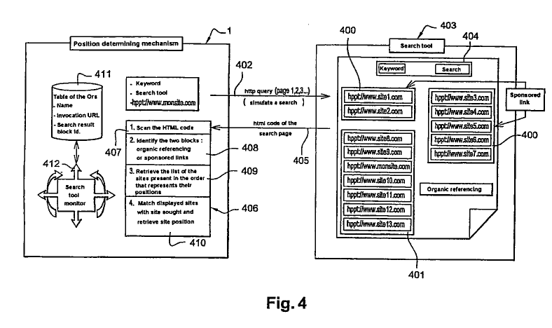

FIG. 4 is schematic view of the mechanism for the real-time computation of the position of an advertisement of a site on a search tool. This mechanism as shown in FIG. 4 is applied to retrieve the position of an advertisement both in a zone 400 of sponsored links and in a zone 401 of organic referencing.

The control unit 1 has a database 411 that inventories the characteristics of the search tool such as the names, the http invocation URL, of each search tool as well as the structure presenting the results of the sponsored links and of the organic referencing in each search tool. The control unit also has a monitor 412 used by the position determining mechanism. The control unit 1 sends an http query 402 to the search tool 403. This http query 402 enables a search to be made in the search tool 403 in using the domain name as a keyword 404. The domain name is the part of an Internet name that specifically identifies the Internet site of a given organization.

For certain search tools, the keyword used is an information technology site of the domain name to tell the search tool to give all the URLs of the domain name site. An information technology site is a location allocated to the implantation of an information technology system. A URL is a string of standardized characters used to identify and locate resources that can be consulted on the Internet and obtain access thereto by means of a browser. The control unit 1 retrieves the html result 405 of this query. The control unit 1 applies operations situated in a program block 406 to the result 405. It applies a scanning operation 407 to this result in searching for the occurrence of the domain name word. It applies an identification operation 408 for the identification of the organic referencing zone 401 and/or the zone 400 of sponsored links. The control unit 1 applies an operation 409 for retrieving a first list of the sites present in the order which represents their positions. The control unit 1 applies a matching operation 410 for matching the displayed sites of this first list with the site being sought and retrieves the position of the site being sought from among the list of the results.

Should the control unit 1 not find the position of the site being sought from among the sites present in the first list, it applies the operations 402 to 410 in a loop. Consequently, it retrieves a second list of the sites present in the order represented by their positions. This second list of sites succeeds the first list of sites. The number of sites present in these lists may be either pre-defined or defined by the control unit 1. The control unit 1 makes the displayed sites of this second list correspond to the site being searched for and retrieves the position of the site being searched for from among the lists of the results.

Should the control unit 1 not find the position of the site being searched for among the sites present in the first list and the second list, then it can retrieve a third list succeeding the second list. The control unit applies the same processing operations to the third list, and so on and so forth.

At the end of a certain predefined number of applications of the operations 402 and 410, the control unit 1 stops the program for retrieving the position of the site being searched for and sends a query of non-availability of the position.

The control unit also has a looped synchronization algorithm used to update the characteristics of the search tools such as the http invocation URL of each research tool as well as the structure for presenting results of the sponsored links and of the organic referencing in each search tool.

This algorithm is used to take reception of and send the data of a search tool in real time through the synchronization of the data for managing campaigns through the pay-per-click management. It also enables the advertiser to continue to manage its campaigns during the synchronization of the system with the database of the search tools.

To this end, the control unit 1, applying the looped synchronization algorithm, applies several successive phases. In a first phase, the control unit determines the list of campaigns of the advertiser. In a second phase, the control unit determines the list of advertisements. In a third, phase, the control unit determines the list of keywords for each advertisement.

After the application of these phases, the advertiser can start performing operations in the pages of the pay-per-click platform, in making queries. This pay-per-click platform is better known as the PPC platform. This pay-per-click platform is a mode of payment for a purchase of advertising space in a website where the sum paid is established solely on the basis of the number of times that a surfer has clicked on an advertising banner of the advertiser.

The data used in each page, for each operation, will be requested by query using solely the database of the system. In the meantime, the control unit 1 will continue to obtain all the attributes of headers and the recording of the tracing of the URLs of the search tool.

Should the advertiser wish to obtain specific data that has not yet been downloaded by the transparently looped synchronizing algorithm, the control unit informs the algorithm that this element is no longer available in this loop. In this case, the control unit reintegrates it into the algorithm for immediate execution. If the data requested by the advertiser cannot be found at this point in time, then the control unit 1 will replace the data requested in the looped synchronization algorithm with a status of failure and a high priority equal to: Retry!

This algorithm of the control unit sharply reduces the processing time for downloading in the prior art, the time being reduced from 40% to 5%. This is due to the fact that the control unit downloads only headers. This algorithm of the control unit also enables the total elimination of the time taken to produce and record the tracing of the URL in the search tool. This gives a gain in time of 40% as compared with the currently estimated time. This is due to the use of the looped synchronization algorithm in the invention.

With this looped synchronization algorithm, the invention enables the advertiser to manage the payment-per-click platform speedily and with greater efficiency. The advertiser is no longer obliged to wait until all the modifications have been updated in the search tool or updated on the basis of the search tool in order to manage its campaigns.

1-20. (canceled)

21. A method for processing digital data relative to real-time performance of an indexing of at least one advertisement in Internet search tools, comprising the steps of:
generating a campaign;
determining a list of advertisements of at least one campaign, said list of advertisements comprising at least one advertisement;
determining a list of keywords for each advertisement of the said of list of advertisements;
determining at least one characteristic for assigning search tools;
determining at least one search tool from a plurality of search tools according to said at least one characteristic;
allocating said at least one campaign to said at least one search tool determined;
assigning each keyword of each advertisement a fixed value;
determining decision-assistance indices;
determining bidding strategies as a function of the decision-assistance indices; and
bidding on each keyword of said each advertisement as a function of the bidding strategies to obtain best indexing of the advertisement of the corresponding keyword.

22. The method of claim 21, further comprising the steps of:
recording data of the campaign in a database;
publishing the campaign;
converting and adapting the campaign to each search tool;
accessing the database of the search tools by applications program interfaces; and
selecting at least one search tool used to publish said list of advertisements.

23. The method of claim 21, further comprising the steps of:
determining number of campaigns to be made;
determining name, language to be used and a geographical target of each campaign;
generating at least one advertisement for said each campaign;
selecting keywords to be used for said each campaign;
assigning maximum set values for each keyword;
validating set values entered for each selected search tool;
regulating increase or decrease in a bidding value of the selected keywords;
validating the bidding value; and
validating a set of parameters comprising search tools, name of said each campaign, advertisement groups and the selected keywords.

24. The method of claim 23, wherein the step of validating the set of parameters comprises the steps of:
recording the set of parameters in a database;
converting and adapting the set of parameters to each search tool; and
sending queries to said database of each search tool in real time for each keyword whose bidding value has been modified.

25. The method of claim 21, further comprising the step of scheduling actions for increasing or decreasing bidding values by:
selecting one or all of the campaigns;
selecting one or all of the advertisements;
selecting at least one keyword;
selecting at least one search tool;
selecting a date, time, time slot indicating a start time and an end time if an action is to be performed in one day;
selecting a starting date, an ending date, days of a week, and the time slot if the action is to be performed during a period of at least two days
scheduling the action to be performed either to increase or decrease a bidding value; and
validating the scheduled action and adding the scheduled action to a list of scheduled actions to be performed automatically.

26. The method of claim 25, further comprising the step of performing each scheduled action in a chronological order.

27. The method of claim 25, further comprising the step of associating a corresponding value of decrease or increase in an effective bidding value to each scheduled action.

28. The method of claim 25, further comprising the step of modifying index of an advertisement in a ranking of advertisements found by said at least one search tool.

29. The method of claim 21, further comprising the step of determining indices of performances for said at least one search tool.

30. The method of claim 21, further comprising step of determining a return-on-investment index.

31. The method of claim 30, wherein the step of determining the return-on-investment index further comprises the steps of:
searching for a number of customers who have viewed said at least one advertisement;
searching among the customers who have viewed said at least one advertisement for a number of new customers;
searching among the customers who have viewed said at least one advertisement for a number of customers who have already made at least one commercial operation with respect to said at least one advertisement;
searching among the number of customers who have viewed said at least one advertisement for those customers who have just performed a commercial operation on said at least one advertisement; and
determining an overall index of loyalty rate of customers for each advertisement based on a number of customers for each customer type.

32. The method of claim 30, wherein the step of determining of the return-on-investment index further comprises the steps of:
searching for a number of sales of products made for each advertisement;
searching for an origin of each sale of products made;
searching for a volume of sales of products relative to a predetermined duration;
searching for a cost of acquisition of each customer to compute an overall cost of sales; and
establishing a hierarchy between different categories of products to determine most attractive products and most effective advertisements.

33. The method of claim 31, wherein the step of determining the return-on-investment index are performed using decision-making assistance algorithm and by tracking a list of keywords entered and a sale resulting from viewing said at least one advertisement by each potential customer.

34. The method of claim 21, further comprising the step of determining a position of an advertisement of a website on said at least one search tool, the position being in a zone of sponsored links or in an organic referencing zone.

35. The method of claim 34, wherein the step of determining the position of the advertisement further comprises the steps of:
a) transmitting an http query to said at least one search tool using a domain name as a keyword;
b) retrieving a html result of said http query;
c) applying a scan operation to the html result to search for an occurrence of the domain name;
d) identifying the organic referencing zone or the zone of sponsored links;
e) retrieving a list of websites present in an order that represents positions of the websites;
f) associating displayed websites of said list of websites with a searched website;
g) retrieving a position of the searched website if an association is obtained step f);
h) repeating steps a) to g) in a loop by transmitting an http request to said at least one search tool for a next results page if an association is not obtained in step f).

36. The method of claim 35, further comprising the step of transmitting a query of non-availability of the position of the searched website and inhibiting step g) of retrieving the position of the search website after a predetermined number of times of repeating steps e)-h).

37. The method of claim 35, further comprising the steps of applying a transparent looped synchronization algorithm in determining header data of said at least one search tool, thereby enabling an advertiser to manage its campaigns in real time by utilizing the header data on demand without waiting for synchronization to end.

38. The method of claim 37, wherein the step of determining of the header data of said at least one search tool further comprises the steps of:
determining names of the campaigns by their identifications;
determining names of application development systems by their identifications; and
determining names of the keywords only by only their identifications.

39. The method of claim 37, further comprising the steps of:
transmitting information to the transparent looped synchronization algorithm that specific data being sought is no longer available in the loop and reintegrating the specific data into the transparent looped synchronization algorithm for immediate execution if it is determined that the specific data has not yet been downloaded by the transparent looped synchronization algorithm; and
replacing the specific data with a failure status and priority equal to “retry” if the specific data cannot be reintegrated into the transparent looped synchronization algorithm.

40. A hub for implementing a method for processing digital data relative to real-time performance of an indexing of an advertisement in Internet search tools, comprising:
an advertiser interface for enabling access by dedicated application servers to a database via data servers for performing the following functions:
generating a campaign;
determining a list of advertisements of at least one campaign, said list of advertisements comprising at least one advertisement;
determining a list of keywords for each advertisement of the said of list of advertisements;
determining at least one characteristic for assigning search tools;
determining at least one search tool from a plurality of search tools according to said at least one characteristic;
allocating said at least one campaign to said at least one search tool determined;
assigning each keyword of each advertisement a fixed value;
determining decision-assistance indices;
determining bidding strategies as a function of the decision-assistance indices; and
bidding on each keyword of said each advertisement as a function of the bidding strategies to obtain best indexing of the advertisement of the corresponding keyword.
